(19) United States
(12) Patent Application Publication
(10) Pub. No.: US 2026/0171676 A1
(43) Pub. Date: Jun. 18, 2026

(54) WIDEBAND HIGH-GAIN BICONE-FED PARABOLIC REFLECTOR

(71) Applicant: Massive Light LLC, Spring, TX (US)

(72) Inventor: Bernd Strassner, Albuquerque, NM (US)

(21) Appl. No.: 19/417,822

(22) Filed: Dec. 12, 2025

Related U.S. Application Data
(60) Provisional application No. 63/735,411, filed on Dec. 18, 2024.

(51) Int. Cl. H01Q 15/16

(52) U.S. Cl. CPC H01Q 15/16

(57) ABSTRACT

An apparatus comprising a biconical antenna configured to radiate energy. A parabolic reflecting dish redirects at least a portion of the radiated energy from the biconical antenna. A support structure suspends the biconical antenna at a focal point of the biconical antenna to radiate the portion of the radiated energy towards the parabolic reflecting dish. A coaxial cable located withing the support structure connects the biconical antenna to an external transceiver.

### CROSS-REFERENCE TO RELATED APPLICATION AND PRIORITY CLAIM

This application claims priority under 35 U.S.C. § 119(e) to U.S. Provisional Patent Application No. 63/735,411 filed on Dec. 18, 2024, which is hereby incorporated by reference in its entirety.

### TECHNICAL FIELD

The following disclosure relates to antennas, and more particularly, to the use of a biconical antenna with a reflector.

### BACKGROUND

Current reflector combinations with antennas have various issues. A major problem is bandwidth limitations inherent to commonly used feed antennas that are paired with parabolic reflectors to project highly directive antenna beams in a particular direction. The bandwidth limitations of these types of feed antennas significantly limit the applications with which the antenna reflector combinations may be utilized. Thus, the use of a feed antenna and reflector to overcome these issues would be greatly beneficial.

### SUMMARY

The present invention, as disclosed and described herein, in one aspect thereof comprises an apparatus comprising a biconical antenna configured to radiate energy. A parabolic reflecting dish redirects at least a portion of the radiated energy from the biconical antenna. A support structure suspends the biconical antenna at a focal point of the biconical antenna to radiate the portion of the radiated energy towards the parabolic reflecting dish. A coaxial cable located withing the support structure connects the biconical antenna to an external transceiver.

### BRIEF DESCRIPTION OF THE DRAWINGS

For a more complete understanding, reference is now made to the following descriptions taken in conjunction with the accompanying drawings in which:

FIG. 1 illustrates a first embodiment of a biconical antenna mounted on a parabolic reflector;

FIG. 2 illustrates a second embodiment of a biconical antenna mounted on a parabolic reflector;

FIG. 3 illustrates a third embodiment of a biconical antenna mounted on a parabolic reflector;

FIG. 4A illustrates the coordinate system associated with the biconical antenna mounted to a parabolic reflector;

FIG. 4B illustrates the front view of a biconical antenna mounted to a parabolic reflector;

FIG. 4C illustrates the side view of a biconical antenna mounted to a parabolic reflector;

FIGS. 5A-5E illustrates various parameter measurements associated with a biconical antenna positioned at the focal point of a parabolic reflector;

FIGS. 6A and 6B illustrates antenna pattern measurements associated with a biconical antenna positioned at the focal point of a parabolic reflector;

FIG. 7A illustrates a mechanical model of a truncated reflector; and

FIG. 7B illustrates a cross section view of a mechanical model showing the cable channel conduits.

### DETAILED DESCRIPTION

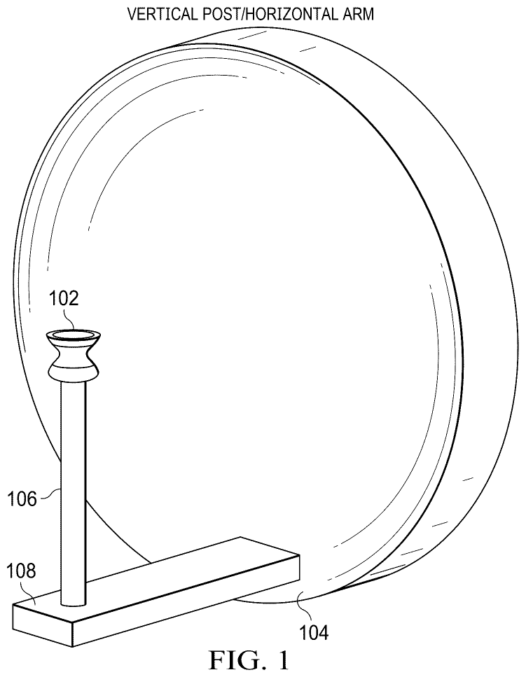

Referring now to the drawings, and more particularly to FIG. 1, there is illustrated a first embodiment of a biconical antenna 102 mounted to a parabolic reflector 104. While parabolic reflectors are discussed herein, other types of reflectors may be used. The antenna 102 is mounted on a cylindrical member 106 that extends downward from the biconical antenna 102 and connects to a rectangular member 108 that supports the cylindrical member 106 and connects to supporting structure on the backside of the parabolic reflector 104. The rectangular member 108 extends from the base of the parabolic reflector 104 substantially parallel to a central axis 110 of the parabolic reflector. The cylindrical member 106 extends substantially perpendicular to the rectangular member 108 to suspend the biconical antenna 102 at the focal point of the parabolic reflector 104. The cylindrical member 106 and rectangular member 108 also provide an interior channel for containing a coaxial cable (not shown) that runs from the biconical antenna 102 to transceiver circuitry located behind the parabolic reflector 104.

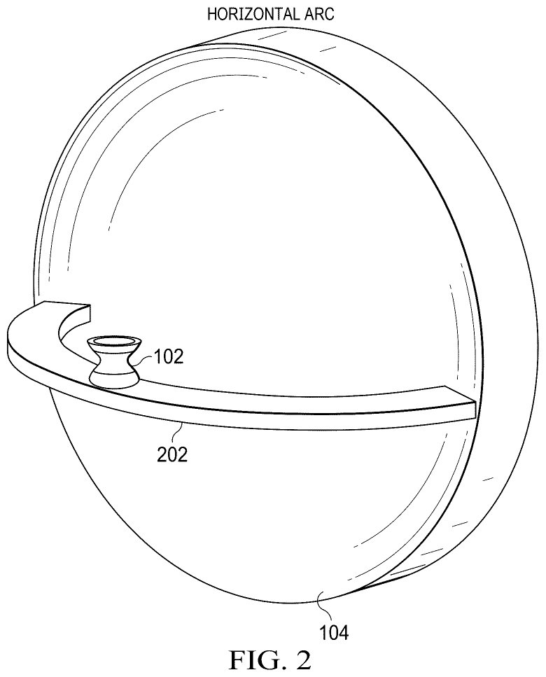

Referring now to FIG. 2, there is illustrated an alternative embodiment wherein the biconical antenna 102 is mounted to the parabolic reflector 104 utilizing an arc shaped member 202 that connects the biconical antenna 102 to opposite sides of the parabolic reflector 104. The arc shaped member 202 extends from the sides of the parabolic reflector 104 substantially near the midpoint of the parabolic reflector 104. The biconical antenna 102 is mounted on the arc shaped member at the focal point of the parabolic reflector 104. As before, the arc shaped member 202 would include a channel therein to enable a coaxial cable to pass from the biconical antenna 102 to one or other edge of the parabolic reflector 104 in order to be connected to a transceiver located on the backside of the parabolic reflector 104.

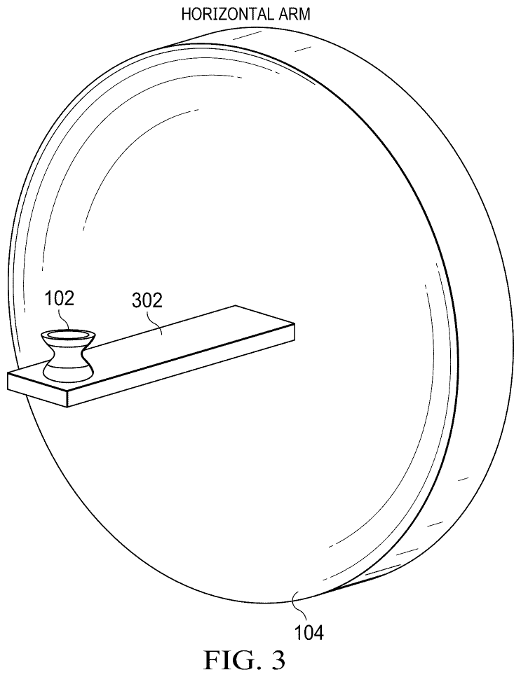

In a third embodiment illustrated in FIG. 3, the biconical antenna 102 is mounted to a horizontal member 302 that extends outward from a substantially center portion of the parabolic reflector 104. Horizontal member 302 suspends the biconical antenna 102 at the focal point of the parabolic reflector 104. The horizontal member 302 also includes an interior channel enabling a coaxial cable to interconnect the biconical antenna 102 with transceiver circuitry located on a backside of the parabolic reflector 104.

The embodiment illustrated in FIG. 1 provides some benefits over the other embodiments illustrated in FIGS. 2 and 3 since transmissions from the biconical antenna 102 and reflected energy from the parabolic dish 104 would have less obstructions from the structure of FIG. 1. The three examples of FIGS. 1-3 are prime focus reflecting antenna systems. Each has a focal point distance (f) to diameter (d) ratio of 0.46. As mentioned previously, there is some blockage associated with each configuration. However, these prime focus configurations results in lower cross-polarization levels than would be the case for an offset parabolic reflector that could be designed to mitigate blockage.

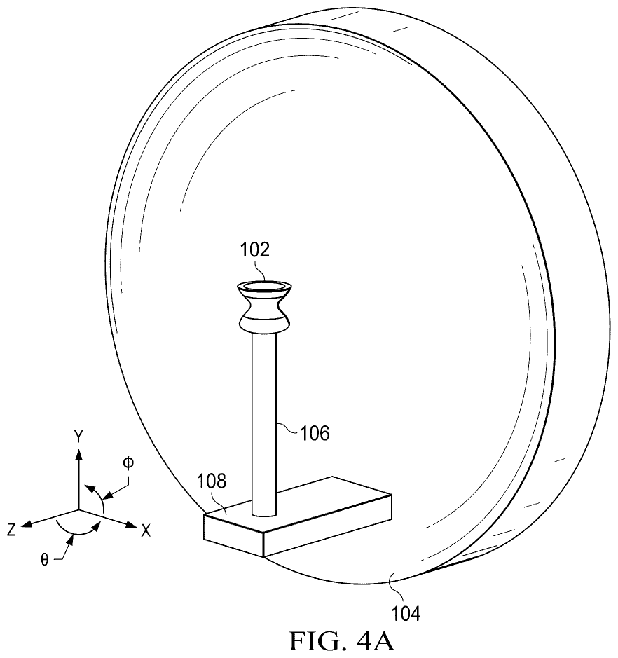

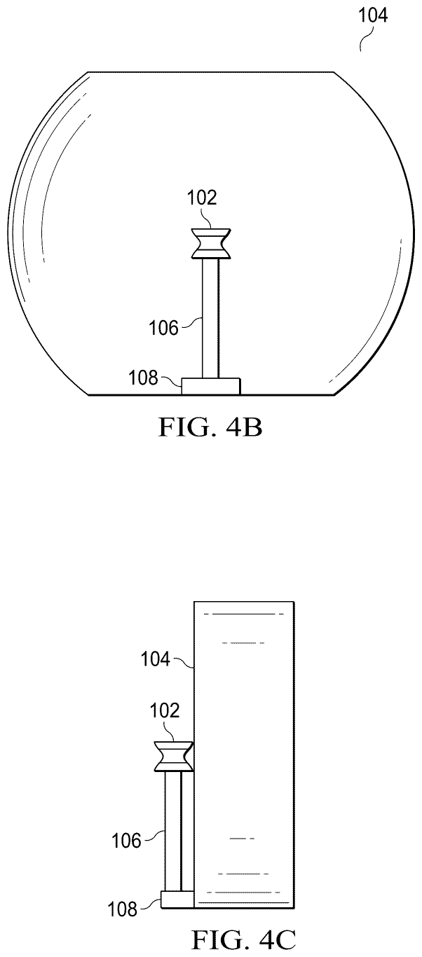

FIG. 4A illustrates a coordinate system associated with the biconical antenna 102 mounted to a parabolic reflector 104. The parabolic reflecting surface of the parabolic reflector 104 ideally has an infinite bandwidth although surface roughness will set an upper limit to the bandwidth. However, the actual bandwidth of a parabolic reflecting antenna is limited by the bandwidth of the feed that excites the parabolic reflector dish 104. Normally, the feed for the parabolic reflector dish 104 is an open-ended waveguide or a small horn antenna, both of which are limited to the waveguide bandwidth that is inherent to these types of feeds. In this case, the biconical antenna 102 operates over a huge instantaneous bandwidth from 3 to 24 GHz and is placed at a focal length (f) distance of 7.7 inches from the parabolic reflecting surface. The diameter (d) of the parabolic reflector 104 is 29 inches. Thus, the f/d ratio of the parabolic reflector 104 is 7.7/29 or approximately 0.27. The range of f/d ratios producing good beam-directed patterns with the greatest radiation efficiency is small at approximately 0.25 since the biconical feed produces donut-shaped omnidirectional radiation patterns.

The parabolic reflector dish 104 diameter is around 4.4 λₒ across at the lowest frequency of 1.8 GHz. At 10 GHz, the dish diameter is 24.6 λₒ, and at 20 GHz, the dish diameter is 49.1 λₒ. The biconical antenna 102 is positioned upon a long vertical cylindrical post 106 that allows the coaxial cable that connects to the biconical antenna 102 to run its length. At the very bottom, the cylindrical post 106 connects to a rectangular support arm 108. The coaxial cable makes a 90° bend at the start of the rectangular arm 108 and travels to the parabolic reflector's backside where it is connected to other system components such as the transceiver.

Referring now also to FIG. 4B, there is illustrated a front view of the biconical antenna 102 mounted to the parabolic reflector 104 via the cylindrical member 106 and horizontal rectangular member 108. Here the top and bottom portions of the reflector's geometry are removed since the electric field in these areas is negligible for the huge frequency range of interest. Removing these portions of the dish will increase the radiation efficiency since the effective antenna area has been reduced without any lowering of gain. This is a consequence of the biconical feed emitting omni-directional donut-shaped patterns.

Referring now also to FIG. 4C, there is illustrated a side view of the biconical antenna 102 mounted to the parabolic reflector 104 via the cylindrical member 106 and horizontal rectangular member 108. The biconical antenna 102 radiates power primarily to its horizon in all directions so putting the biconical feed antenna 102 closer to the parabolic reflector 104, as shown in FIG. 4C, will result in more of the antennas energy being impingent upon the parabolic reflector surface of the parabolic reflector 104 which will increase the overall gain and reduce sideways facing lobes from the antenna/parabolic reflector combination. The biconical antenna feed 102 throws energy laterally and in all directions. Thus, there is energy spillover which translates to some inefficiencies. In effect, the bicone-fed reflector gives up some gain in order to realize huge instantaneous bandwidths. The parabolic reflecting antenna operates from 1.8 GHz to 20 GHz comprising some or all of the L, S, C, X, Ku and K bands. Performance beyond 20 GHz looks to be good as well, but the SMA feeding will start to over mode past 25 GHz.

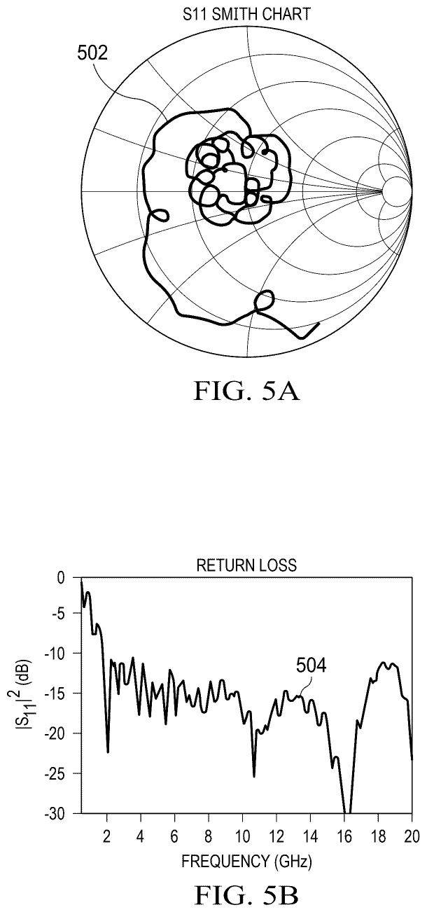

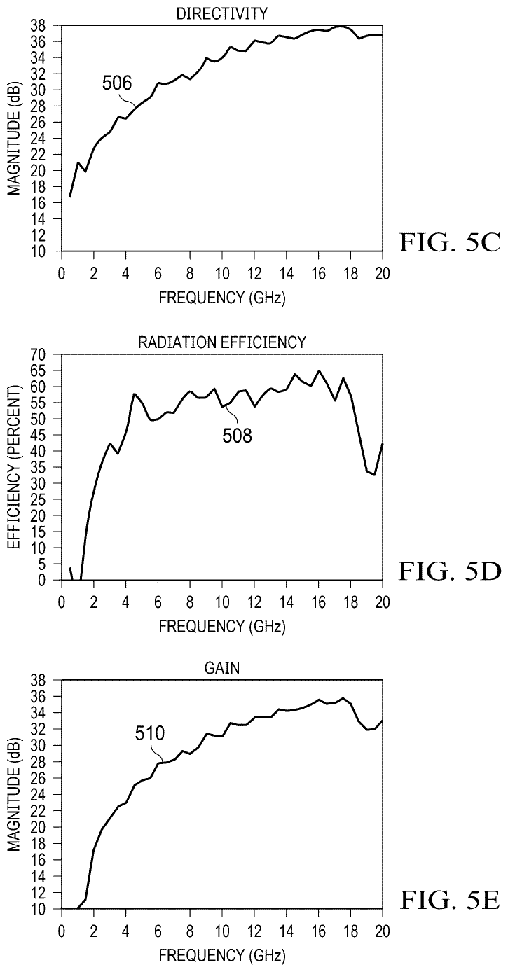

Referring now to FIGS. 5A-5E, there are illustrated various parameters associated with the biconical antenna 102/parabolic reflector 104 combination. These include a Smith chart impedance cluster 502 (FIG. 5A), the return loss 504 (FIG. 5D), the directivity 506 (FIG. 5C), the radiation efficiency 508 (FIG. 5D)and gain 510 (FIG. 5E). The Smith chart 502 impedance cluster for the input port of the biconical feed reflecting antenna 102 is tight around the middle 50-ohm point. This corresponds to the excellent S₁₁ return losses 504 which are below the 2:1 VSWR for the entire 1.8 to 20 GHz range. The radiation efficiency is around 50% which is expected since about 50% of the biconical feeds energy misses the dish. The gain peaks at 36 dB for the dish size chosen, pointing to this feed/dish's ability to produce high gain.

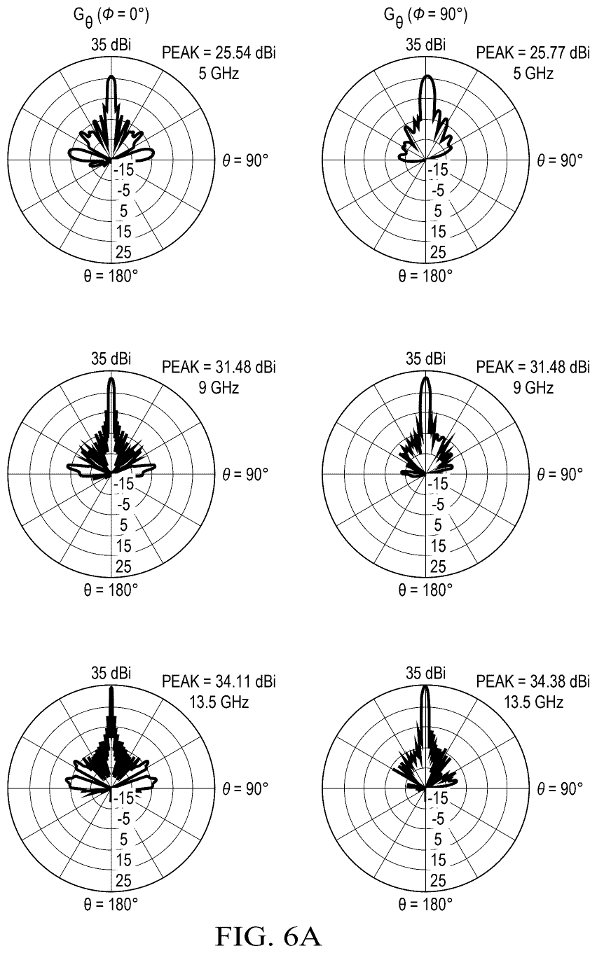

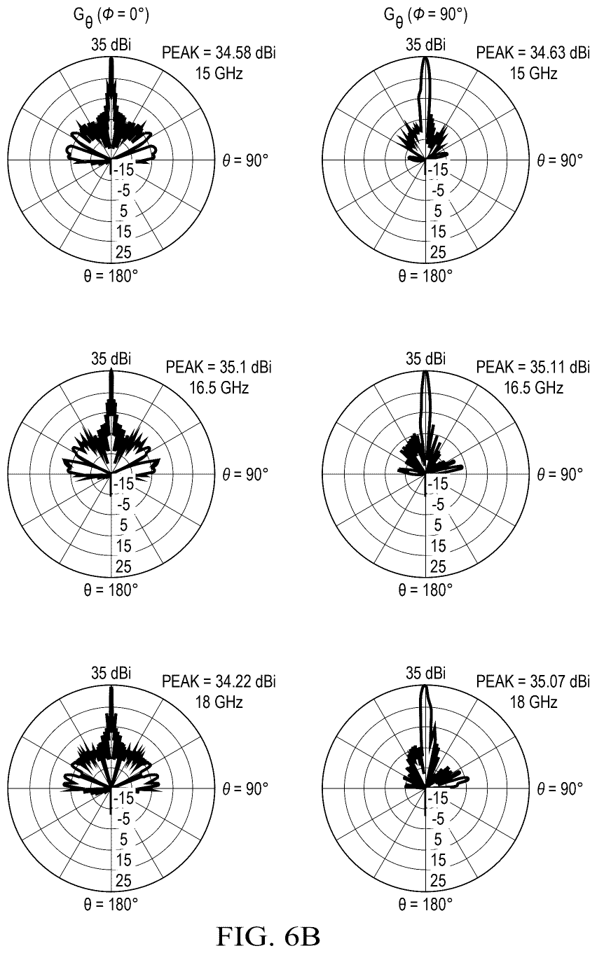

Referring now to FIGS. 6A-6B, there are illustrated cross-sectional orthogonal principal plane views of the z-directed antenna beams at φ=0° and 90° for different arbitrary frequencies. The figures show cross-sections at 5 GHz, 9 GHz, 13.5 GHz, 15 GHz, 16.5 GHz and 18 GHz. The two orthogonal co-polarized pattern cuts E_{θ} (φ=0°) in the x-z plane and E_{θ} (φ=90°) in the y-z plane bisect the main beam and show desirable beam patterns from 3 to 20 GHz. Sidelobe levels vary between 13 dB and 27 dB. The E_{θ} (φ=0°) principal plane cut has narrower beamwidths than the E_{θ} (φ=90°) cuts. This is due to the feed illumination of the dish parabolic reflector 104 being wider in the x direction and narrower in the y direction. The E_{θ} (φ=0°) cuts also have 13 dB sidelobes since the illumination in that direction is uniform across the entire dish's curved surface. The parabolic reflector 104 can be made smaller to broaden up the patterns'main beams, although the peak gains will go down as a consequence since the aperture size has now decreased.

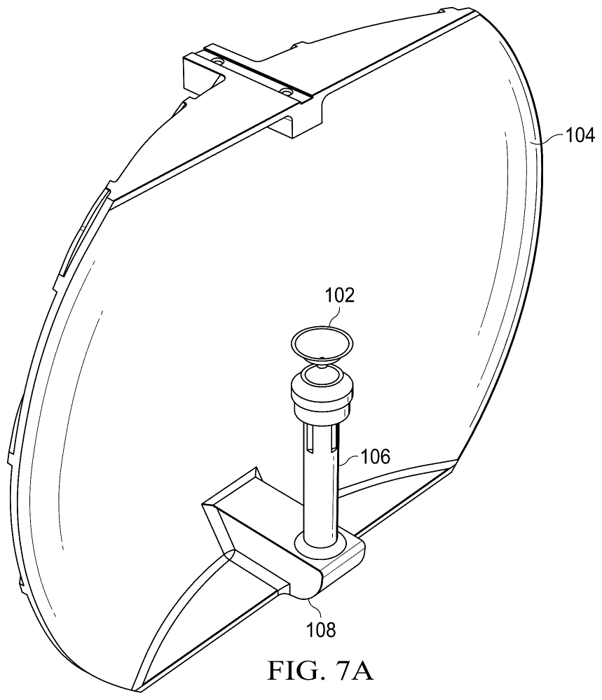

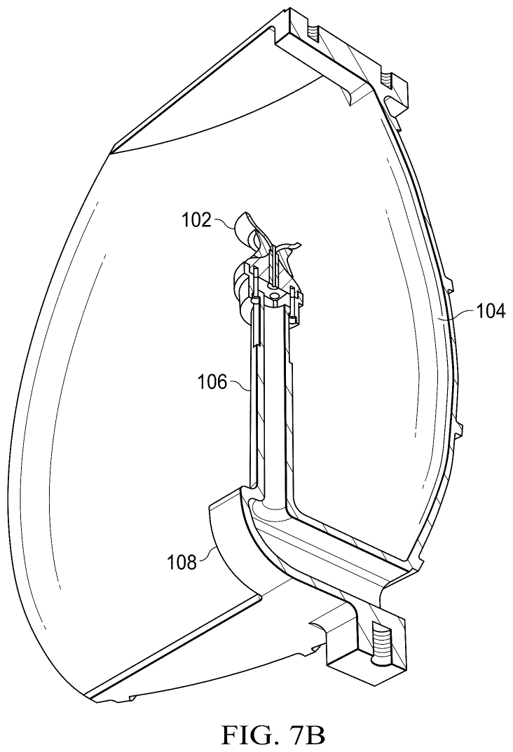

FIG. 7A illustrates a mechanical model of a truncated parabolic reflector. Due to the biconical antenna feed 102 radiating radially to its horizon, the top and bottom of the reflecting dish can be subtracted away since there is a very low electric field in these areas. FIG. 7B shows a cross-sectional view of the reflector antenna with particular emphasis on the coax cable conduits 702, 704 that connect the biconical feed to the backside of the reflector dish. With the bottom portion of the dish removed, the coaxial cable that connects to the feed is now shorter in length since the cylindrical vertical member 106 is now shorter. This decreases cable losses which are higher at higher frequencies. The positioning of the feed at the focal point is also more motion stable due to the shorter support post.

Although the preferred embodiment has been described in detail, it should be understood that various changes, substitutions and alterations can be made therein without departing from the spirit and scope of the invention as defined by the appended claims.

What is claimed is:

1. An apparatus comprising:
a biconical antenna configured to radiate energy;
a parabolic reflector for redirecting at least a portion of the radiated energy from the biconical antenna;
a support structure for suspending the biconical antenna at a focal point of the biconical antenna to radiate the portion of the radiated energy towards the parabolic reflector; and
a coaxial cable located withing the support structure for connecting the biconical antenna to an external transceiver.

2. The apparatus of claim 1, wherein the support structure further comprises:
a first member extending from a base of the parabolic reflector substantially parallel to a central axis of the parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

3. The apparatus of claim 1, wherein the support structure further comprises:
an arced member having a first end connected to a first point on an edge of the parabolic reflector and a second end connected to a second point on the edge of the parabolic reflector, wherein the biconical antenna is supported between the first end and the second end of the arced member; and
wherein the arced member defines a channel therein for the coaxial cable to run between the biconical antenna and the external transceiver.

4. The apparatus of claim 1, wherein the support structure further comprises:
a first member horizontally extending from the parabolic reflector, wherein the first member has a first end connected to the parabolic reflector and a second end supporting the biconical antenna; and
wherein the first member defines a channel therein for the coaxial cable to run between the biconical antenna and the external transceiver.

5. The apparatus of claim 1, wherein the parabolic reflector further comprises a truncated parabolic reflector having a top portion and a bottom portion of the parabolic reflector removed to increase radiation efficiency.

6. The apparatus of claim 1, wherein the biconical antenna radiates energy in a range of 1.8 GHz to 25 GHz.

7. The apparatus of claim 1, wherein the support structure further comprises:
a first member extending from a point on a face of the parabolic reflector between an edge of the parabolic reflector and a central point of a face of the parabolic reflector substantially parallel to a central axis of the parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

8. The apparatus of claim 1, wherein the biconical antenna is located at a focal length distance (f) from the parabolic reflector and the parabolic reflector has a diameter (d), further wherein a ratio of f/d is in a range of approximately 0.27-0.46.

9. An apparatus comprising:
a biconical antenna configured to radiate energy, wherein the biconical antenna radiates energy in a range of 1.8 GHz to 25 GHz;
a parabolic reflector for redirecting at least a portion of the radiated energy from the biconical antenna;
a support structure for suspending the biconical antenna at a focal point of the biconical antenna to radiate the portion of the radiated energy towards the parabolic reflector;
wherein the biconical antenna is located at a focal length distance (f) from the parabolic reflector and the parabolic reflector has a diameter (d), further wherein a ratio of f/d is in a range of approximately 0.27-0.46; and
a coaxial cable located withing the support structure for connecting the biconical antenna to an external transceiver.

10. The apparatus of claim 9, wherein the support structure further comprises:
a first member extending from a base of the parabolic reflector substantially parallel to a central axis of the parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

11. The apparatus of claim 9, wherein the support structure further comprises:
an arced member having a first end connected to a first point on an edge of the parabolic reflector and a second end connected to a second point on the edge of the parabolic reflector, wherein the biconical antenna is supported between the first end and the second end of the arced member; and
wherein the arced member defines a channel therein for the coaxial cable to run between the biconical antenna and the external transceiver.

12. The apparatus of claim 9, wherein the support structure further comprises:
a first member horizontally extending from the parabolic reflector, wherein the first member has a first end connected to the parabolic reflector and a second end supporting the biconical antenna; and
wherein the first member defines a channel therein for the coaxial cable to run between the biconical antenna and the external transceiver.

13. The apparatus of claim 9, wherein the parabolic reflector further comprises a truncated parabolic reflector having a top portion and a bottom portion of the parabolic reflector removed to increase radiation efficiency.

14. The apparatus of claim 9, wherein the support structure further comprises:
a first member extending from a point on a face of the parabolic reflector between an edge of the parabolic reflector and a central point of a face of the parabolic reflector substantially parallel to a central axis of the parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

15. An apparatus comprising:
a biconical antenna configured to radiate energy, wherein the biconical antenna radiates energy in a range of 1.8 GHz to 25 GHz;
a truncated parabolic reflector having a top portion and a bottom portion removed to increase radiation efficiency for redirecting at least a portion of the radiated energy from the biconical antenna;
a support structure for suspending the biconical antenna at a focal point of the biconical antenna to radiate the portion of the radiated energy towards the parabolic reflecting dish; and
a coaxial cable located withing the support structure for connecting the biconical antenna to an external transceiver.

16. The apparatus of claim 15, wherein the support structure further comprises:
a first member extending from a base of the truncated parabolic reflector substantially parallel to a central axis of the truncated parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

17. The apparatus of claim 15, wherein the support structure further comprises:
an arced member having a first end connected to a first point on an edge of the truncated parabolic reflector and a second end connected to a second point on the edge of the truncated parabolic reflector, wherein the biconical antenna is supported between the first end and the second end of the arced member; and
wherein the arced member defines a channel therein for the coaxial cable to run between the biconical antenna and the external transceiver.

18. The apparatus of claim 15, wherein the support structure further comprises:
a first member horizontally extending from the truncated parabolic reflector, wherein the first member has a first end connected to the truncated parabolic reflector and a second end supporting the biconical antenna; and
wherein the first member defines a channel therein for the coaxial cable to run between the biconical antenna and the external transceiver.

19. The apparatus of claim 15, wherein the support structure further comprises:
a first member extending from a point on a face of the truncated parabolic reflector between an edge of the truncated parabolic reflector and a central point of a face of the truncated parabolic reflector substantially parallel to a central axis of the truncated parabolic reflector;
a second member extending substantially perpendicular to the first member, the second member having a first end connected to the first member and a second end connected to the biconical antenna; and
wherein the first member and the second member each define a channel therein for the coaxial cable to run between the biconical antenna and the external transceiver.

20. The apparatus of claim 15, wherein the biconical antenna is located at a focal length distance (f) from the truncated parabolic reflector and the truncated parabolic reflector has a diameter (d), further wherein a ratio of f/d is in a range of approximately 0.27-0.46.
